(19) United States
(12) Patent Application Publication
(10) Pub. No.: US 2025/0117649 A1
(43) Pub. Date: Apr. 10, 2025

(54) DEPENDENCY-AWARE INCIDENT LINKING FOR LARGE-SCALE CLOUD SERVICES

(71) Applicant: Microsoft Technology Licensing, LLC, Redmond, WA (US)

(72) Inventors: Supriyo GHOSH, Bangladore (IN); Jimmy WONG, Seattle, WA (US); Chetan BANSAL, Seattle, WA (US); Rakesh Jayadev NAMINENI, Sammamish, WA (US); Mohit VERMA, Seattle, WA (US); Saravanakumar RAJMOHAN, Redmond, WA (US); Karish GROVER, New Delhi (IN)

(21) Appl. No.: 18/520,931

(22) Filed: Nov. 28, 2023

(30) Foreign Application Priority Data
Oct. 6, 2023 (IN) 202311067107

(51) Int. Cl. G06N 3/08; G06F 16/901

(52) U.S. Cl. CPC G06N 3/08; G06F 16/9024

(57) ABSTRACT

Systems and methods are provided for generating and updating a dependency graph that is used in combination with textual information about incidents to improve incident-linking suggestions. Systems and methods are also provided for generating, training, and using a machine learning model configured to perform incident linking using both graph data and text data. Beneficially, these systems and methods align the graph data and text data in order to more efficiently and accurately leverage information from the multi-modal data.

### CROSS-REFERENCE TO RELATED APPLICATION

This application claims the benefit of and priority to Indian Provisional Patent Application No. 202311067107, which was filed Oct. 6, 2023, entitled “SYSTEMS AND METHODS FOR DEPENDENCY-AWARE INCIDENT LINKING,” and which application is expressly incorporated herein by reference in its entirety.

### BACKGROUND

Large-scale cloud operators run tens of thousands of services with highly complex architecture and interdependencies between the services. Despite significant reliability efforts, large-scale cloud services inevitably experience production incidents that can significantly impact service availability and customer satisfaction. These incidents can be extremely expensive in terms of customer impact, revenue loss via violation of service-level agreements, and manual toil required from On-call engineers (OCEs) to resolve them. Worse, in many cases, due to inter-dependencies among services, one failure can cause cascading effects that propagate errors to downstream services. As engineers from every service team set up their automated watchdogs with specific alert rules for faster detection of incidents, such cascading effect leads to many alerts being reported from different services within a short period, which is referred to as alert storms.

These problems are highly impactful but notoriously challenging to handle without proper domain expertise and knowledge of inter-dependencies among services. OCEs often inspect these related incidents in silos leading to higher engagement of engineering resources, repetitive efforts, and manual toil, and delay in recovering service health. On the other hand, multiple independent faults may also arise within a short period, which should then ideally be examined by OCEs separately in a timely fashion. Therefore, accurately clustering similar and related incidents is paramount to reducing the burden of OCEs and ensuring the reliability of cloud systems.

Such problems become even more severe in air-gapped and sovereign cloud environments where the incidents need to be managed by general third-party vendors who are not subject matter experts due to stringent data egress policy. In addition, these environments require special secure access which is limited to a handful of people and the domain experts may not have this type of access.

One way to help identify and deal with these problems is through incident linking so that related events can be consolidated and duplication of efforts and resources and be reduced. Existing incident linking models mainly focus on textual and contextual information (e.g., title, description, severity, impacted components) of incidents. However, such configurations generally perform poorly when incidents arise from interdependent services. In view of the foregoing, there is a need for improved methods and systems that accurately and efficiently facilitate incident management across large-scale cloud services.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

Systems and methods are provided for generating and updating a dependency graph that is used in combination with textual information about incidents to improve incident-linking suggestions. Systems and methods are also provided for generating, training, and using a machine learning model configured to perform incident linking using both graph data and text data. Beneficially, these systems and methods align the graph data and text data to more efficiently and accurately leverage information from the multi-modal data.

Systems and methods are provided for generating a dependency graph for cross-domain incident management. For example, systems access domain data comprising a plurality of domains and generate a node for each domain of the plurality of domains in the dependency graph. Additionally, systems access a first set of link data comprising a first set of correlating links between the plurality of domains and generate an edge between two or more nodes of the dependency graph for each correlating link included in the first set of correlating links. Systems also access a second set of link data comprising historical correlating links previously generated between two or more domains of the plurality of domains and dynamically update the dependency graph by augmenting one or more edges of the dependency graph with the historical correlating links. Finally, systems generate an updated dependency graph based on augmenting one or more edges of the dependency graph with the historical correlating links. This provides a robust global dependency graph that can be used to improve the accuracy of suggested links between incidents in a large-scale cloud system.

Systems and methods are also provided for performing incident linking in large-scale cloud services. For example, systems identify a new incident occurring in large-scale cloud services and access textual information about the new incident. Systems also access a dependency graph comprising a plurality of nodes representing a plurality of domains and a plurality of edges representing a plurality of correlating links between different domains of the plurality of domains. The systems, in some instances, also periodically update the dependency graph with a set of historical correlating links between the different domains of the plurality of domains.

After accessing textual information, the systems generate a set of text embeddings for the incident. The systems also generate a set of graph embeddings for the incident based on a sub-graph of the dependency graph associated with the new incident. After generating both sets of embeddings, the systems align the sets of text and graph embeddings and generate a final set of joint embeddings for the incident based on the aligning of the set embeddings with the set of graph embeddings.

Systems and methods are also provided for training a machine learning model to predict correlation links between incidents in large-scale cloud services. For example, in order to train the machine learning model, systems access a set of graph embeddings based on a dependency graph comprising a plurality of nodes representing a plurality of domains and a plurality of edges representing a plurality of correlating links between different domains of the plurality of domains.

In some instances, systems generate a subgraph for each domain included in the plurality of domains. Systems also access a set of textual embeddings corresponding to a plurality of incidents. Systems then align the set of textual embeddings with the set of graph embeddings to generate an aligned set of textual embeddings. Finally, systems train the machine learning model on a combination of a particular subgraph and a subset of the aligned set of textual embeddings corresponding to a subset of the set of graph embeddings associated with the particular subgraph. This process is repeated until the model is trained on all of the available subgraphs of the dependency graph.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS AND REFERENCE TO APPENDIX

In order to describe the manner in which the above-recited and other advantages and features can be obtained, a more particular description of the subject matter briefly described above will be rendered by reference to specific embodiments that are illustrated in the appended drawings. Understanding that these drawings depict only typical embodiments and are not therefore to be limiting in scope, embodiments will be described and explained with additional specificity and detail through the use of the accompanying drawings in which:

FIG. 1 illustrates an example embodiment of a machine learning model configured to perform incident linking.

FIG. 2 illustrates a detailed example embodiment of the graph processing layers of FIG. 1.

FIG. 3 illustrates a detailed example embodiment of the text processing layers of FIG. 1.

FIG. 4 illustrates a detailed example embodiment of the alignment layers of FIG. 1.

FIG. 5 illustrates a detailed example embodiment of the final layers of FIG. 1.

FIG. 6 illustrates an example incident management process flowchart that utilizes the machine learning model of FIG. 1 for generating incident links.

FIG. 7 illustrates an example workflow dependency flowchart that utilizes the machine learning model of FIG. 1 for generating link suggestions.

FIG. 8 illustrates one embodiment of a flow diagram having a plurality of acts associated with a method for generating and updating a dependency graph used as input to the machine learning model of FIG. 1 to perform incident linking.

FIG. 9 illustrates one embodiment of a flow diagram having a plurality of acts associated with a method for using the machine learning model of FIG. 1 to perform incident linking.

FIG. 10 illustrates one embodiment of a flow diagram having a plurality of acts associated with a method for training the machine learning model of FIG. 1 to perform incident linking.

FIG. 11 illustrates an example computing environment in which a computing system incorporates and/or is utilized to perform disclosed aspects of the disclosed embodiments.

### DETAILED DESCRIPTION

The disclosed embodiments can be utilized to facilitate improvements in the identification and resolution of incidents affecting large-scale cloud operators.

As will be described in more detail herein, there are many technical problems that exist with conventional systems for performing incident linking. Some of these technical are associated with a conventional system's inability to accurately and efficiently perform incident linking for cross-team and cross-workload incidents. This problem is caused, in part, because many conventional systems are currently configured to only utilize textual descriptions of incidents. While some conventional systems may utilize graph information, along with textual information, to link incidents, they still suffer technical problems associated with accuracy and reliability resulting from the inability to effectively utilize joint embeddings or they have low-quality joint embeddings due to a misalignment of the underlying graph and text embeddings.

The disclosed embodiments are directed to technical solutions that can be used to help address some of these technical problems. For example, the disclosed embodiments are directed to systems and methods that leverage both textual data and graphical dependency data to improve the suggested incident links. Additionally, the disclosed embodiments achieve the technical benefit of preventing the degradation of final joint embeddings by first aligning the textual embeddings with the graphical embeddings that can be used to more accurately and reliably link corresponding incidents. These, along with many other technical benefits, will become more apparent through the description provided herein.

Some of these technical benefits are especially apparent in large-scale cloud operators, for example, that run tens of thousands of services with highly complex architecture and interdependencies between the different services. Despite current reliability efforts to ensure continuous availability of services, production incidents (e.g., unplanned interruptions or performance degradation of one or more services) can adversely impact customer interaction and satisfaction with the large-scale cloud operator. These incidents can be extremely expensive in terms of customer impact, revenue loss via violation of service-level agreements, and manual toil required from On-Call Engineers (OCEs) to resolve the incidents. For example, the estimated cost for one hour of service downtime for a shopping webpage on a major shopping day can reach upwards of $100 million.

In many cases, due to inter-dependencies among services, one failure can cause cascading effects that propagate errors to downstream services. Usually, engineers from different service teams set up their automated watchdogs or monitors with specific alert rules for faster detection of incidents. However, the cascading effects of inter-dependent incidents can lead to many alerts being reported from different services within a short span of time, also referred to as an alert storm. One technical problem that arises is that alert storms are difficult to sort through and determine which incidents are the originating incidents to resolve first.

Incident management systems are configured to perform incident aggregation and incident linking to aid in organizing and classifying incidents. Incident aggregation is for clustering incidents that are caused by the same failure, while incident linking determines whether two incidents are similar (e.g., related, duplicate, dependent, or responsible). Existing incident linking models mainly focus on textual and contextual information (e.g., title, description, severity, impacted components, etc.) of incidents. Such incident linking generally performs poorly when the incidents are coming from different teams and workloads. This is one of the technical problems associated with conventional incident linking and management systems. To address this challenge, disclosed embodiments are directed to improved incident management systems that leverage dependency relationship information among different teams and services to provide improved incident-linking information that is more accurate and reliable than incident-linking information, especially for cross-team and cross-workload scenarios, that is generated without such dependency information.

Accordingly, the disclosed embodiments are directed to systems and methods for dependency-aware incident linking, including a framework that jointly leverages textual and service dependency graph information to improve the accuracy and coverage of incident links coming from different teams and services. The framework includes, among other components, a textual embedding module. The textual embedding module uses textual description (e.g., title, topology) and categorical information (i.e., monitor ID, failure type, owning team name, etc.) of incidents. The textual description and categorical information are converted to numerical vectors using TF-IDF or any other model that can generate vector representations of the information.

In some embodiments, the textual description is passed through an LSTM layer, and categorical information is passed through two linear layers with dropouts. The processed textual description and processed categorical information are then concatenated to generate the final textual embeddings.

The framework also includes a graph embedding module. The system first generates the dependency graph among owning teams using (i) system metadata information available in a dependency tracking system (DTS) tool and (ii) historical incident link information. The system identifies the different teams and workflows that are operating with the large-scale cloud operator. Dependency links are identified between one or more teams that indicate which teams and/or workflows depend on each other (e.g., for inputs/outputs). The system then generates a sub-graph for each owning team from the global dependency graph. In some instances, each sub-graph is generated by taking three-hop distance neighbor nodes (for both incoming and outgoing edges).

These sub-graphs are then converted into low-dimensional vector space using a node2vec graph transformer or another transformer to generate the final vector representations. Finally, these represented vectors are sent through graph representation networks (e.g., Graph convolution network, graph attention network, or GraphSAGE network) for generating and learning the final low-dimensional embeddings of nodes from the graph embedding module that uncovers the relationship between different sub-graph architectures.

After computing the embeddings from the textual components (e.g., title, topology, monitor ID, failure type, and/or owning team name) and graphical components (e.g., sub-graph corresponding to the owning team of the incident), the system combines the textual embeddings and the graph embeddings. However, due to the misalignment of vector representations, a simple concatenation of embeddings from textual and graph modules may perform poorly. This is another technical problem associated with conventional systems for incident linking.

One technical benefit provided by the disclosed embodiments includes the improvement of the alignment of the vector representations. For example, in some instances, the system uses the Orthogonal Procrustes method from linear algebra for projecting the text embeddings to graph embedding space in order to align the embeddings. Then, a singular value decomposition (SVD) method is used to compute an orthogonal matrix which is then multiplied with textual embeddings to align it with graph embeddings. Finally, the system concatenates graph embeddings with projected text embeddings and passes the joint embeddings through a set of linear neural networks and non-linear ReLU activation functions to get the final learned representation of an incident.

The disclosed systems and methods beneficially provide a framework for incident linking which leverages graphical information, in addition to textual information. The systems and methods also beneficially align the textual and graphical data in the same embedding space so that the representations can be learned together, instead of separately. This type of alignment improves the accuracy and coverage of incident links, especially ones that arise from different teams and services.

Other technical benefits include providing reliable public and private cloud services, including sovereign clouds, at scale. The disclosed systems and methods provide improved service quality and customer experience. Additionally, the manual toil from both engineers and incident managers is reduced by providing information on related alerts so that relevant incidents can be clustered together. In turn, this allows the incidents to be resolved more quickly and efficiently.

### Machine Learning Model for Incident Linking

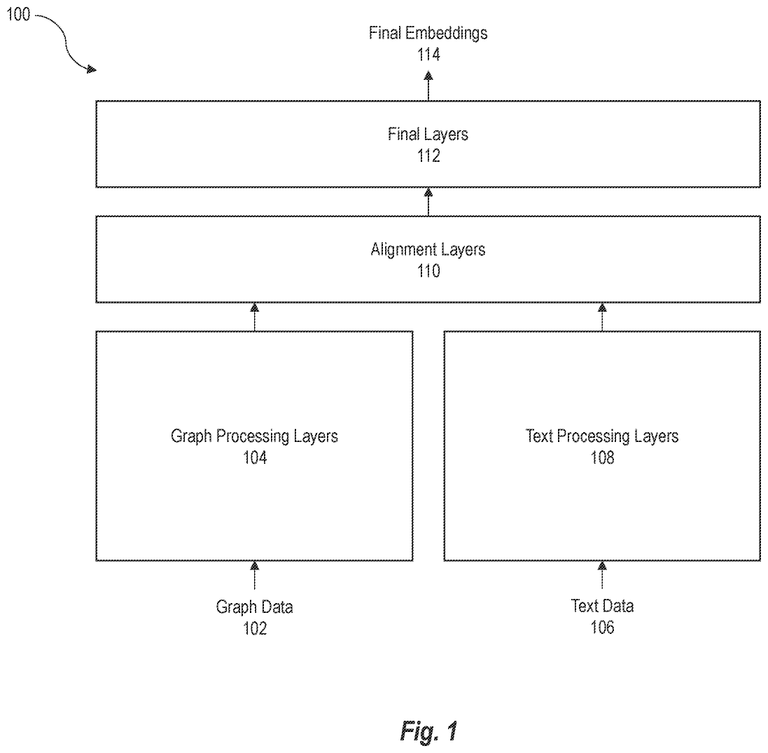

Attention will now be directed to FIG. 1 which illustrates an example configuration of a machine learning model 100. As shown in FIG. 1, machine learning model 100 comprises graph processing layers 104, text processing layers 108, alignment layers 110, and a set of final layers 112. The machine learning model 100 takes in graph data 102 and text data 106 as input and generates final embeddings 114 as output. The graph data 102 is processed by the graph processing layers 104. The text data 106 is processed by the text processing layers 108.

The machine learning model 100 considers both the textual description (e.g., text data 106) and service structural information (e.g., graph data 102) from each incident to learn the relationship between the incidents. These features are fed into their respective modules so that the textual embedding module (e.g., text processing layers 108) can extract information from textual and categorical information, while the graph embedding module (e.g., graph processing layers 104) can extract information from the dependency graph. Ultimately, the machine learning model 100 is configured to generate a set of final embeddings as output which are then used to compute the similarity score between the incidents.

### Graph Processing Layers

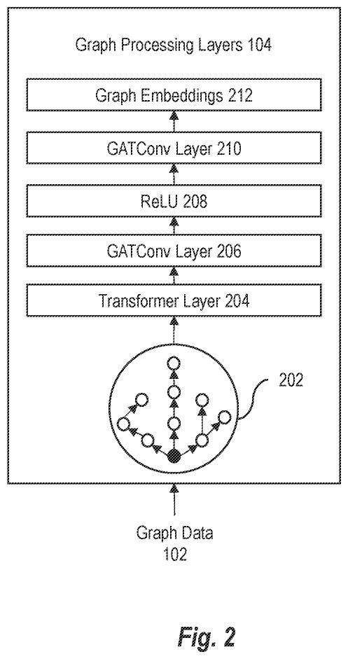

Attention will now be directed to FIG. 2, which illustrates a detailed example embodiment of the graph processing layers 104. The graph processing layers 104 are configured to receive graph data 102 as input and generate a set of graph embeddings 212 as output. An example of graph data 102 is a sub-graph 202 of a global dependency graph that corresponds to a particular owning team. In some instances, the graph processing layers comprise a plurality of different processing layers such as transformer layers (e.g., transformer layer 204), graph attentional operators (e.g., GATConv Layer 206, GATConv Layer 210), and rectified linear units (e.g., ReLU 208).

Understanding the dependencies among different teams in a hyperscale cloud system is a non-trivial task due to the complex interactions between the vast number of services included in the cloud system. In order to better understand these dependencies, the system is configured to generate a dependency graph or global dependency graph. Each node of the graph represents a unique team and each edge in the graph represents a relationship between two or more teams.

To generate the dependency graph, the system leverages the system's metadata information available within a dependency tracking system (DTS) associated with the cloud system. The DTS curates different information to link the services, including: shared subscription information, shared resource information, and logs of service communication using a domain name system (DNS). From this, the system obtains a partial dependency graph by adding a link from the source to the dependent team for each record available in the DTS tool. The partial dependency graph is then augmented with additional edges generated from historical incident relationships.

For each related link, we have the information regarding the owning team of both the parent incident and the child incident. Therefore, for each related link, a new edge is created in the graph between the owning team of the parent incident and the owning team of the child incident. By employing dependency links from these two different data sources, the system generates the global dependency graph.

After the global dependency graph is generated, the system encodes the information available to be extracted from the global dependency graph. For example, to represent the semantics of the dependency graph, the system generates a sub-graph for each owning team included in the global dependency graph. In some instances, the system takes a 3-hop distance to neighbor nodes for both incoming and outgoing edges to generate the sub-graph. It should be appreciated, however, that any number of hop distances may be employed based on the desired configuration of the sub-graph. Notably, the model achieves improvement in the precision, recall, F1-score, and accuracy of performing incident linking when using a range between 0-5 neighbor hops, or notably, between 1-4 neighbor hops. In some instances, the greatest improvement is achieved with 3 neighbor hops to generate the sub-graphs.

These sub-graphs are then converted to low-dimensional vector space using a graph transformer with random walks. In some instances, the walk length equals 20 and the number of walks equals 100. The graph transformer is used to learn continuous feature representations of nodes in the sub-graph. Finally, these represented vectors are sent through graph representation networks for learning the low-dimensional embeddings of nodes from the graph embedding module (e.g., graph processing layers). This process uncovers the relationship between different sub-graph architectures.

There are several different graph representation networks that can be used to obtain the final sub-graph embeddings. The systems and methods described herein are configured to utilize one or more of the following networks: a graph convolution network, a graph attention network, and a GraphSAGE network. A graph convolution network is a scalable semi-supervised learning approach for the classification of nodes in the graph. In some instances, the network is motivated by a first-order approximation of spectral graph convolutions.

A graph attention network (GAT) employs masked self-attention layers, similar to a canonical transformer-based attention network. The nodes are configured to attend to their neighborhoods' features, and therefore, assign different importance or weights to nodes of the same neighborhood. A GraphSAGE network is a general inductive learning framework that can efficiently generate embeddings for previously unseen nodes by leveraging current nodes' features. Thus, rather than learning embeddings for each node separately, it generates embeddings by sampling and aggregating features from a node's local neighborhood. This allows the network to generalize well to unseen nodes.

### Text Processing Layers

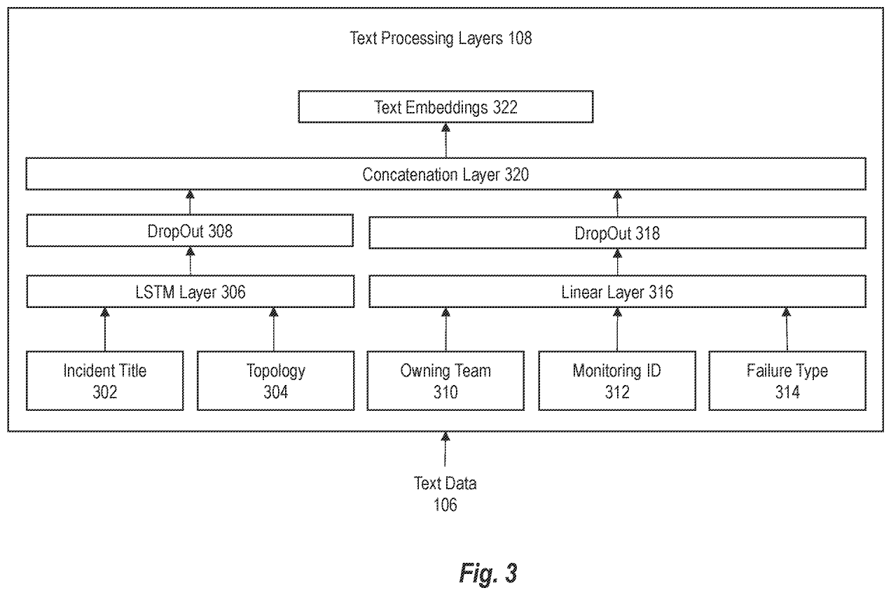

Attention will now be directed to FIG. 3, which illustrates a detailed example embodiment of the text processing layers 108. The text processing layers 108 are configured to receive text data 106 and generate a set of text embeddings 322 as output. In some instances, the text processing layers 108 comprise long short-term-memory (LSTM) layers (e.g., LSTM Layer 306), linear layers (e.g., linear layer 316), drop out layers (e.g., DropOut 308, DropOut 318), and concatenation layers (e.g., concatenation layer 320).

Different types of text data 106 include incident title 302, topology 304, owning team 310 (e.g., owning team name or other identifier), monitoring identifier (e.g., monitoring ID 312), and failure type 314. An incident title 302 describes the symptoms of the incident, including the location, impacted customers, service health information, etc. In addition, topological information (e.g., topology 304) includes details about the impacted region, machine information (e.g., machine name, data center name, device group name), deployment ring information, and impacted service information. This information beneficially improves the understanding of the potential links with other incidents. The system learns the relationship between two incidents by learning the semantic representation of this text data 106.

To learn a mapping from texts in natural language into a representational number vector in the latent space, the system, in some instances, uses a TF-IDF (Term Frequency times Inverse Document Frequency) vectorizer. These numerical values are then passed through an LSTM layer, followed by a dropout layer to get the final text embeddings. In addition, the system uses other categorical features (incident owning team name (e.g., owning team 310), unique identification number of the monitor that reported the incidents (e.g., monitoring ID 312), and failure type reported by the monitor (e.g., failure type 314). This additional categorical information beneficially improves the ability of the machine learning model to identify the incident relationship. In some instances, to generate embeddings for these categorical features, the system uses a TF-IDF vectorizer followed by a neural network with a fully connected layer.

After generating the respective embeddings for the textual and categorical information, the embeddings from the textual information and the embeddings from the categorical information are concatenated together to obtain intermediary text embeddings. These intermediary text embeddings are then fed through another linear layer that generates text embeddings 322. Text embeddings 322 represent the learned vector for the textural description (including textual and categorical information) of each incident. It should be appreciated that text data 106 includes both textual information and categorical information as described above.

### Alignment Layers

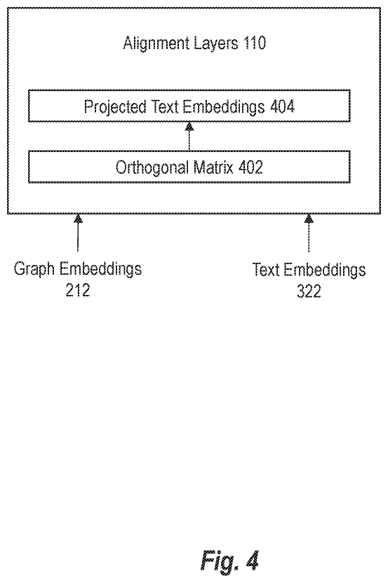

Attention will now be directed to FIG. 4, which illustrates a detailed example embodiment of the alignment layers 110. The alignment layers are configured to receive the graph embeddings 212 and the text embeddings 322 and generate projected text embeddings 404 that are aligned to the graph embeddings 212. By aligning the graph embeddings 212 and text embeddings 322, the concatenation of the different embeddings is improved, which in turn improves the quality and accuracy of the final embeddings. In some instances, the alignment layers 110 comprise an orthogonal matrix layer (e.g., orthogonal matrix 402) which is used to produce the projected text embeddings 404.

As described earlier, a simple concatenation of embeddings from the textual module (e.g., text processing layers 108) and the graphical module (e.g., graph processing layers 104) leads to poor performance in incident linking due to the misalignment of the different vector representations. Thus, to address this failing of conventional systems, the disclosed embodiments are directed to systems and methods for performing incident linking that align the text embeddings and graph embeddings before combining them for downstream analysis and further processing.

In some instances, the text embeddings 322 and graph embeddings 212 are aligned by projecting the text embeddings 322 to the graph representational space. In this manner, the text embeddings 322 are now in the same representation space as the graph embeddings 212 and can now be combined without misalignment issues. It should be appreciated that, in some instances, the graph embeddings 212 could be projected to the textual representation space. Additionally, or alternatively, the graph embeddings 212 and the text embeddings 322 could both be projected into a new shared representation space and then combined.

In some instances, the system utilizes a method of alignment referred to as Orthogonal Procrustes. This method first involves finding the nearest orthogonal matrix associated with the different embeddings. The orthogonal matrix can be obtained by using singular value decomposition (SVD). Thus, the system is able to generate projected text embeddings 404 that are now aligned with the graph embeddings 212.

### Final Layers

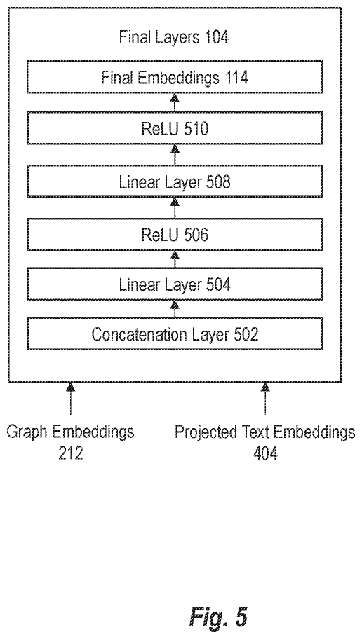

Attention will now be directed to FIG. 5, which illustrates a detailed example embodiment of the final layers 112. The final layers 112 are configured to receive the graph embeddings 212 and the projected text embeddings 404 as input and generate final embeddings 114 as output. In some instances, the final layers 112 comprise a concatenation layer (e.g., concatenation layer 502) which is configured to concatenate the graph embeddings 212 and projected text embeddings 404. The concatenated embeddings are then processed by a series of different layers such as linear layers (e.g., linear layer 504, linear layer 508), and ReLU layers (e.g., ReLU 506, ReLU 510).

### Model Training

To learn the similarity score between two incidents, the final joint embeddings are trained based on a neural network (e.g., a Siamese neural network) configured for learning an entity-matching task. In some instances, the neural network comprises two twin neural networks, with identical structures. The two twin neural networks share the same set of parameters and weights. Given a pair of incidents with their known relationship (i.e., ground truth), the two networks separately learn the vector representation of the two incidents. This structure learns the embeddings in a deep layer and places semantically similar features closer to each other.

Finally, the neural network is trained in a supervised learning fashion in accordance with given incident relationship labels. Then, to train the machine learning model 100, the system generates training data comprising triplets of incidents. The triplet comprises an anchor incident, along with a corresponding positive-related incident and a corresponding negative-related incident. The model is then trained according to a loss function based on the triplet training data. Notably, because the text embeddings and graph embeddings can be aligned, only one Siamese network is needed in order to learn the representations, instead of multiple separate networks for each representation space, which would be required without the referenced alignment.

### Model Deployment

Once the neural network is trained, the system deploys the model, wherein the model is now used to predict the relationship between different pairs of incidents. When an incident is reported, the system retrieves a set of incidents from a particular lookback time period. This lookback time period is tunable and updateable, either automatically based on the characteristics of the incidents or based on user input. This lookback time period can also be used to update the global dependency graph, in that the global dependency graph can be augmented or updated with historical link data from the determined lookback time period.

For each retrieved incident, the system passes the embeddings corresponding to the incident, along with other reported incident embeddings, to the trained neural network to get the similarity score. If the similarity score meets or exceeds a predefined threshold value, then the incidents are classified as linked incidents. In some instances, the system is also able to classify which type of linked incident (i.e., a duplicate link, a related link, a responsible link, or a cross-team or cross-workload link).

These classified links are then presented to system engineers as suggested or predicted links. The system engineers are then able to validate or reject these suggestions. This feedback is then used to further train the neural network and is also used to update the global dependency graph.

### Model Performance

With the alignment of the textual embeddings and graphical embeddings, the model is able to gain significant improvement over conventional models, for example, that use concatenation without alignment. In some instances, the disclosed model achieves between a 12%-14% improvement in the F-1 Score and a 13%-15% improvement in the accuracy of incident linking over conventional systems and methods. The disclosed model also achieves a 20% improvement in precision and a 6% improvement in recall over the baseline models. These improvements are especially pronounced in cross-team and cross-workload incidents.

Additionally, because of the dynamically updated nature of the global dependency graph, the graph is more accurate and more complete. This improves the downstream accuracy of the predicted links between different incidents.

### Incident Management Systems

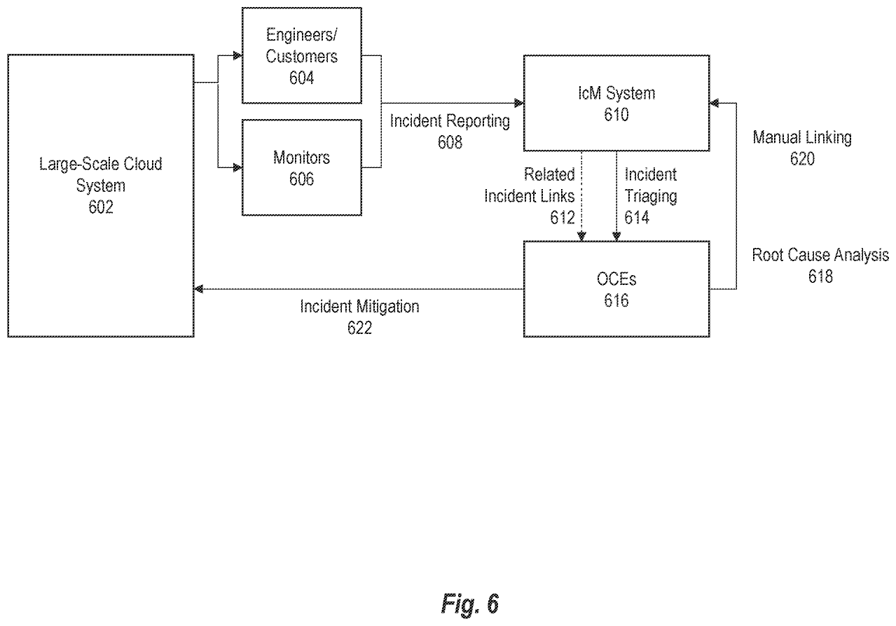

Attention will now be directed to FIG. 6, which illustrates an example process flow for incident management of large-scale cloud systems. As shown in FIG. 6, system 600 comprises a large-scale cloud system 602, engineers and customers 604, monitors 606, an information classification and management system (e.g., IcM System 610), and OCEs 616. The lifecycle of an investigated incident typically has four stages: (1) detection, (2) Triaging, (3) Diagnosis, and (4) Mitigation.

As part of the detection stage, incidents occurring within the large-scale cloud system 602 are identified by engineers and customers 604, as well as by other monitoring systems (e.g., monitors 606). To quickly detect failures within a service, engineers design automated watchdogs (e.g., monitors 606) that continuously monitor the system's health and report an incident when an anomaly in service is detected. These are referred to as monitor-reported incidents (MRIs). Incidents can also be reported by internal engineers or external customers of a given service. These are referred to as customer-reported incidents (CRIs). The disclosed embodiments provide improved linking suggestions for the different reported incidents, particularly for monitor-reported incidents.

The incidents are reported through an incident reporting 608 to the IcM System 610. The IcM System 610 is able to identify related incident links 612 which are sent to the OCEs 616.

As part of the triaging stage, the IcM System 610 performs incident triaging 614 and transmits corresponding information to the OCEs 616. Thus, once an incident is reported, a team of OCEs quickly investigates the details and routes the ticket to the appropriate OCEs. This incident triaging process, in some instances, can take multiple rounds to reach the responsible team. Using the disclosed embodiments, the incident tickets are able to reach the right team of OCEs in a faster, more efficient manner.

As part of the diagnosis stage, the OCEs 616 also transmit information such as root cause analysis results 618 and links determined by manual linking 620 back to the IcM System 610. The system then performs incident mitigation 622 in order to fix the incidents and update the large-scale cloud system 602 to recover the service health. This process is also improved because the system, as disclosed herein, provides improved suggestions for which incidents should be linked together. By providing improved link suggestions to OCEs, the links generated for different related incidents are more accurate and are able to be identified more quickly, thus allowing the services to be recovered more quickly.

As part of incident linking, it is beneficial to identify what type of link should be generated. The different types of links are based on the relationship between two or more incidents. For example, some types of links include duplicate links, related links, responsible links, and cross-team incident links. If two linked incidents originate from the same failure or malfunction of a certain component, the incidents are linked via a duplicate link. As the incidents can be reported by different sources (e.g., customers, engineers, monitors, etc.), sometimes multiple incidents are reported for the same failure. In some cases, even multiple monitors tracking the same health metric can report multiple duplicate incidents for the same anomaly. Thus, by accurately linking duplicate incidents together via duplicate links, the disclosed embodiments achieve improved linking capabilities, including preventing multiple system engineers from working to solve different incidents from the same failure source. This saves many types of resources, including time and money.

In some instances, the nature and description of two incidents are different but both are triggered from a common fault. These are referred to as related incidents which are identified via related incident links. These incidents are neither duplicates nor does one incident cause the other incident sequentially.

When one failure has a cascading effect that impacts other services due to the dependencies among each other, one incident sequentially leads to other incidents. In these scenarios, the incidents are referred to as responsible incidents. Any incidents arising from a particular responsible incident are linked via a responsible incident link. For example, if the database in a particular region is impacted due to storage or networking issues, it can lead to anomalies in products that leverage that underlying storage or network. In conventional systems, these incidents are challenging to link together, unless the OCEs have a deeper understanding and expertise of system functionalities and dependencies. Thus, by leveraging both textual data and graph data from the global dependency graph, the disclosed embodiments beneficially generate suggestions to OCEs that already incorporate the dependencies that improve the accurate linking of responsible incidents.

Another type of incident link is cross-team incident link. In IcM systems, a large number of linked incidents are generated from different teams. There could be two types of cross-team incidents. One type occurs when two incidents arise from different teams but from the same workload. These are referred to as cross-team incidents. Another type occurs when two incidents arise from different workloads. These are referred to as cross-workload incidents.

In conventional systems, the cross-team or cross-workload links can be challenging to detect, especially when the text data used to analyze two possible cross-team or cross-workload incidents include descriptions of different aspects of what otherwise is the same team and/or workload. The different descriptions can increase the distance between the incidents in the representational space and leads to a reduced similarity score when the similarity score should be higher. Accordingly, dependency information is important for identifying links between these cross-team and cross-workload incidents. Thus, by leveraging both text and graph data, the disclosed systems are able to achieve improved incident linking, even for cross-team and cross-workload incidents.

### Example Workflows

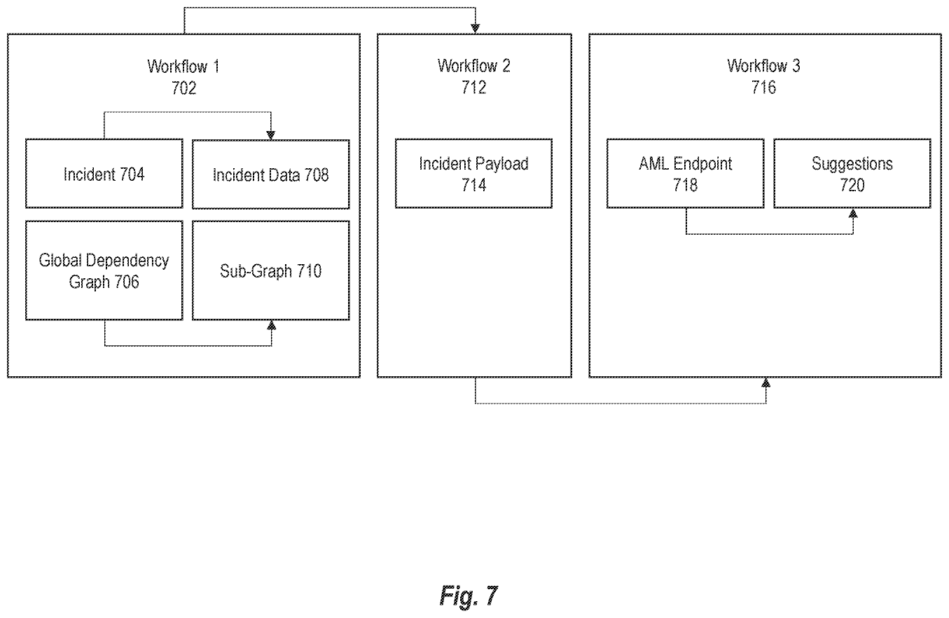

Attention will now be directed to FIG. 7, which illustrates example embodiments of different workflows. For example, workflow 1 (workflow 702) (i) converts incidents 704 to incident data 708 and (ii) generates a sub-graph 710 from the global dependency graph 706. Workflow 2 (workflow 712) then calculates an incident payload 714 based on information and data received from workflow 1. Finally, in workflow 3 (workflow 716) the AML endpoint 718 is called and generates suggestions 720 (i.e., identified or predicted links between incidents).

For the production deployment, the system deploys the trained incident linking model (e.g., machine learning model 100) using a machine learning platform (e.g., Azure machine learning or AML) to create an AML endpoint for the model. For each newly created incident, textual information corresponding to the newly created incident is gathered and passed along with the sub-graph of the incident-owning team to the AML endpoint. The model is then called to generate a set of final embeddings for the newly created incident.

The system compares each incoming incident's embeddings to the embeddings of all incidents that were created in the last lookback time-window to calculate the embedding distances. In some instances, the lookback period value is set to the 90th percentile value of the created time difference between pairs of historically linked incidents (e.g., 4 hours). However, any lookback time period can be used, e.g., a predetermined number of minutes, hours, days or even weeks.

If the embedding distances are lower than a predefined distance threshold value (or the similarity scores meet or exceed a similarity score threshold value), the system generates a positive link. Positive links are then sent as link suggestions to OCEs who are then able to use the link suggestions to more quickly and accurately determine root causes, find related issues, or join the incident bridge faster. In some instances, the link suggestions are used by the system to automatically determine root causes or find related issues.

The link suggestions can be communicated or presented to OCEs through different channels, including: IcM's discussion section, emails, or other virtual chatbot (e.g., Teams). The link suggestions are displayed at a user interface (not shown) with information about the incident including an identifying number and description, the owning team name, time differential, a confidence score for the link suggestion, and a prompt to either accept or reject the link suggestion.

If an OCE accepts a link suggestion, by selecting an accept link suggestion, the link is classified as a true positive. If the OCE rejects a link suggestion, by selecting a reject link suggestion, the link is classified as a false positive. The OCEs are then presented with a user input that prompts them to provide a justification for the link rejection, such as by entering textual descriptions in an input field or by selecting a justification from a displayed listing of prepared justifications. This rejection and accompanying justification are used to update and further improve the machine learning model 100 by leveraging the expertise and domain knowledge of the OCEs. In particular, OCE feedback is used to generate new feeback loop training data that is used to refine the training of the model. The model can be deployed within multiple dependent workflows, as shown in FIG. 7.

For example, the system leverages automation functionalities within the IcM system that are built using logic applications (e.g., Azure Logic Apps) as the means for end-to-end inference. IcM automation is able to natively connect to IcM data, which assists in collecting incident data when an incident is newly created. Workflow 1 is triggered when an incident is created and collects the incident data from IcM. Workflow 2 is triggered by Workflow 1 and prepares the incident payload to pass to the AML endpoint. Workflow 3 is triggered by Workflow 2. Workflow 3 calls an instantiation of the machine learning model 100 through the AML endpoint and passes the incident payload as input to the model instantiation.

The model is then able to predict incident links and send the link suggestions to the OCEs. Thus, the AML endpoint performs the following functions: generating embeddings for an incoming incident with the relevant dependency sub-graph, storing the embedding data in a database, calculating the distances between pairs of incidents, and returning as a response the pairs of incidents that should be linked and sent to the OCEs. In some instances, the real-time AML endpoint is utilized for inference with single data points (e.g., one pair of incidents at a time). Additionally, or alternatively, the endpoint can be extended to perform batch inference for analyzing and suggesting higher numbers of incident links for a given reported incident.

### Example Methods

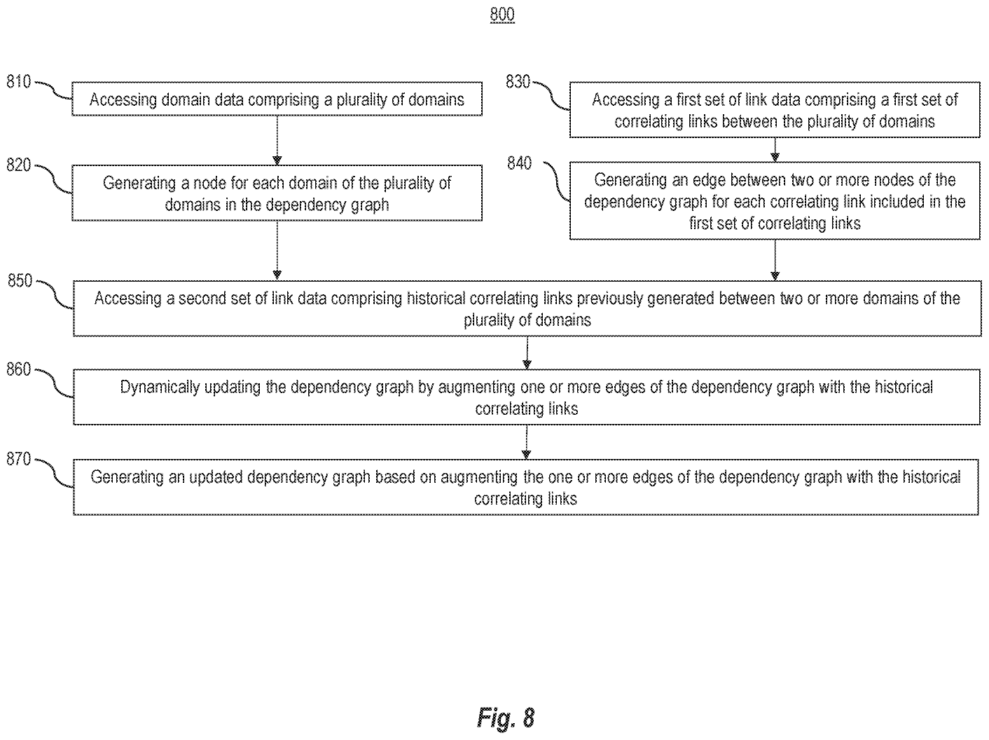

Attention will now be directed to FIG. 8, which illustrates a flow diagram or method 800 that includes various acts (act 810, act 820, act 830, act 840, act 850, act 860, and act 870) associated with exemplary methods that can be implemented by computing system 1110 for generating and updating a dependency graph. A first illustrated act is provided for accessing domain data comprising a plurality of domains (act 810). Systems then generate a node for each domain of the plurality of domains in the dependency graph (e.g., graph data 102) (act 820). Notably, each domain of the plurality of domains can represent different entities. For example, in some instances, each domain represents a particular enterprise team. In other instances, each domain represents a particular service or component.

Systems also access a first set of link data comprising a first set of correlating links between the plurality of domains (act 830) and generate an edge between two or more nodes of the dependency graph for each correlating link included in the first set of correlating links. In some instances, the first set of correlating links comprises self-reported correlating links between domains included in the plurality of domains.

After generating the initial set of nodes and edges, systems then access a second set of link data comprising historical correlating links previously generated between two or more domains of the plurality of domains (act 850) and dynamically update the dependency graph by augmenting one or more edges of the dependency graph with the historical correlating links (act 860). In some instances, the second set of link data comprises historical correlating links from a predetermined timeframe.

As a result, systems generate an updated dependency graph based on augmenting one or more edges of the dependency graph with the historical correlating links (act 870). In some embodiments, systems perform additional acts to aid in updating the dependency graph. For example, in some instances where the historical link data is obtained from a particular timeframe, before dynamically updating the dependency graph, systems update the predetermined timeframe from which the historical correlating links are selected.

Additionally, or alternatively, systems apply weights to the link information, such as by placing more significance on recent historical correlating links than older historical correlating links.

Generating and updating dependency graphs in this manner provides many technical benefits that solve technical problems associated with conventional systems. For example, conventional systems utilize graph structure data that arises from relationships between individual incidents, or even individual components of a system. However, ultimately, a specific team of engineers or a particular system service must be able to identify the incident causing the system failure and perform mitigating steps to fix the issue. A particular team or system service may be associated with multiple components and/or may be in charge of fixing multiple different incidents. Because the disclosed embodiments rely on a dependency graph that represents the relationships between the teams/services (i.e., domains) that will be “owning” the incident and related mitigation steps, the system is able to provide better suggested links to the right teams in a more efficient and more accurate way than conventional systems that rely solely on dependency data between individual incidents or even components.

Additionally, by providing a tunable timeframe by which to update the dependency graph described herein, each dependency graph can be tuned to a specific timeframe that is more relevant to the new incident that has been identified in order to provide more relevant and higher quality graph embeddings to predict/suggest links for the new incident. Another technical benefit related to these dependency graphs includes the ability to generate a sub-graph that is associated with a particular owning team. This type of sub-graph is not able to be generated directly from an incident dependency (or failure impact incident graph). By generating sub-graphs related to a specific team, the graph embeddings used to predict a suggested incident link are improved. These sub-graphs can also be used for improved training processes for training models to predict incident links, as described throughout.

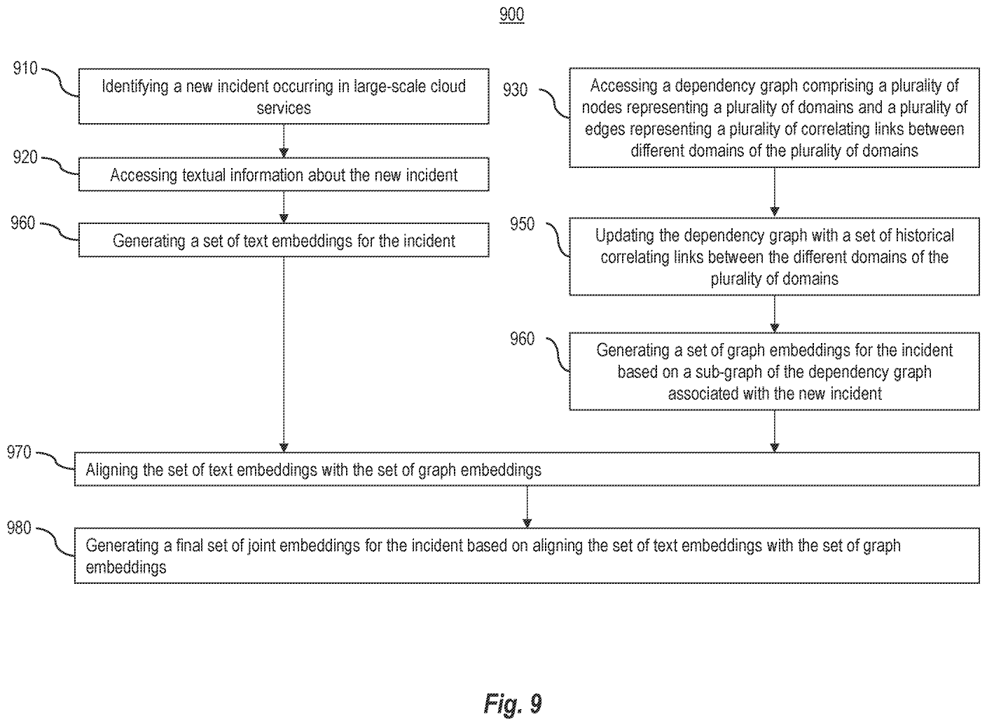

Attention will now be directed to FIG. 9, which illustrates a flow diagram or method 900 that includes various acts (act 910, act 920, act 930, act 940, act 950, act 960, act 970, and act 980) associated with exemplary methods that can be implemented by computing system 1110 for using a machine learning model to perform incident linking. A first illustrated act is provided for identifying a new incident (e.g., incident reporting 608) occurring in large-scale cloud services (e.g., large-scale cloud system 602) (act 910) and accessing textual information (e.g., text data 102) about the new incident (act 920). In some instances, the textual information comprises an incident title (e.g., incident title 302) and topological information (e.g., topology 304), categorical information such as a monitoring identifier (e.g., monitoring ID 312), a failure type (e.g., failure type 314), and/or an owning team identifier (e.g., owning team 310)), or other metadata. Other metadata can include timestamps, component sources, frequency of incident type, or severity level of incident. By including different types of textual information, the systems are able to generate more robust and information-dense embeddings to be used in providing information for incident linking.

After accessing textual information, the systems generate a set of text embeddings (e.g., text embeddings 322) for the incident (act 930). In some instances, after generating the set of text embeddings, systems map the text embeddings into a high-dimensional semantic embedding space.

Systems also access a dependency graph (e.g., graph data 102) comprising a plurality of nodes representing a plurality of domains and a plurality of edges representing a plurality of correlating links between different domains of the plurality of domains (act 930). By utilizing a dependency graph that represents dependencies between domains associated with the large-scale cloud system, like owning teams, systems are better able to generate link suggestions that are based on links already identified for different domains within the cloud system. The systems, in some instances, periodically update the dependency graph with a set of historical correlating links between the different domains of the plurality of domains (act 950). By augmenting the dependency graph with historical information, the dependency graph is up to date with the latest findings and results of incident linking. Beneficially, the dependency graph can also be tuned to different timeframes of historical data.

The systems also generate a set of graph embeddings (e.g., graph embeddings 212) for the incident based on a sub-graph (e.g., subgraph 202) of the dependency graph associated with the new incident (act 960). In some instances, systems also map the set of graph embeddings to a low-dimensional embedding space. By breaking up the dependency graph into subgraphs for a particular domain, the machine learning model is more quickly able to generate more relevant graph embeddings for the incident related to the corresponding subgraph.

After generating both sets of embeddings, systems then align (see, alignment layers 110) the set of text embeddings with the set of graph embeddings (act 970). By aligning the multi-modal embeddings, systems are able to generate improved joint embeddings that are more accurate and retain higher-quality information from the different sets of embeddings. In some instances, aligning the set of text embeddings with the set of graph embeddings further comprises projecting the set of text embedding into a graph embedding space associated with the set of graph embeddings (see, projected text embeddings 404). In such instances, different alignment methods can be used, including an Orthogonal Procrustes method (see, orthogonal matrix 402).

After aligning the different sets of embeddings, systems generate a final set of joint embeddings for the incident based on aligning the set of text embeddings with the set of graph embeddings (act 980). In some instances, prior to generating the final set of joint embeddings, systems concatenate (i) the set of text embeddings that have been aligned with the set of graph embeddings with (ii) the set of graph embeddings (see, concatenation layer 502). This final set of joint embeddings leverages both graph data and text data that have been aligned. This improves the accuracy and efficiency of predicting incident links.

In some systems and methods, additional acts are performed to use the set of joint embeddings to generate suggested incident links. For example, systems are able to predict an incident correlating link (e.g., related incident links 612 and/or suggestions 720) between the new incident and a previously received incident based on calculating a similarity score between the final set of joint embeddings for the new incident and a final set of joint embeddings for the previously received incident.

After generating the incident correlating link, systems are configured to display the incident correlating link between the new incident and the previously received incident (e.g., sending related incident links 612 to OCEs 616). Subsequently, systems are configured to receive user input accepting or rejecting the incident correlating link. Then systems can update the dependency graph based on the user input accepting or rejecting the incident correlating link. This further improves the dependency graph as well as future incident link suggestions.

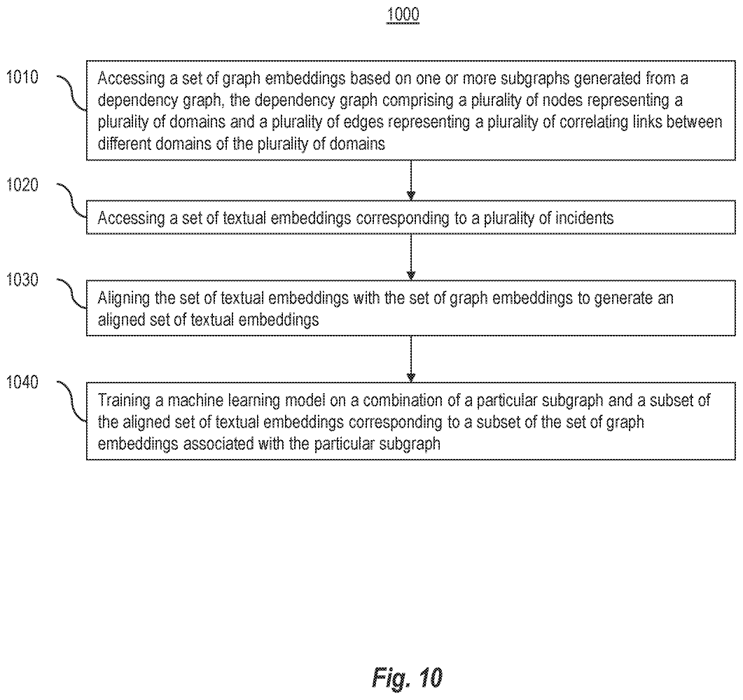

Attention will now be directed to FIG. 10, which illustrates a flow diagram or method 1000 that includes various acts (act 1010, act 1020, act 1030, and act 1040) associated with exemplary methods that can be implemented by computing system 1110 for training a machine learning model to generate final joint embeddings of text and graph data to facilitate incident linking.

A first illustrated act is provided for accessing a set of graph embeddings based on a dependency graph (e.g., graph data 102) comprising a plurality of nodes representing a plurality of domains and a plurality of edges representing a plurality of correlating links between different domains of the plurality of domains (act 1010). In some instances, systems generate a subgraph for each domain included in the plurality of domains. Systems also access a set of textual embeddings corresponding to a plurality of incidents (act 1020). Systems then align the set of textual embeddings with the set of graph embeddings to generate an aligned set of textual embeddings (act 1030). Finally, systems train the machine learning model on a combination of a particular subgraph and a subset of the aligned set of textual embeddings corresponding to a subset of the set of graph embeddings associated with the particular subgraph (act 1040). This process is repeated until the model is trained on all of the available subgraphs of the dependency graph.

In some instances, systems generate training data that includes set of triplets. For example, some training data includes triplet incidents including a positive related incident, a negative related incident, and an anchor incident corresponding to the positive related incident and the negative related incidents. This training data is also used to train the machine learning model on the set of training data.

In light of the detailed description herein, including example computing systems below, the disclosed systems and methods achieve many technical benefits over conventional systems and methods for performing incident linking. For example, the textual description and the dependency structure contain critical information about different aspects of incident links. Thus, by providing systems and methods to utilize both modes of data, the incident-linking model is improved by leveraging information learned from both the text data and the graph data.

Furthermore, by generating a dependency graph that represents the relationship between different teams and services, the system is able to declutter the complex relationship between cross-team incidents. The dependency graph is further improved because it is dynamically updated with historical linking data, as well as feedback based on acceptance or rejection of suggested links. In addition, generating sub-graphs with a particular number of neighbor nodes further improves the processing of the graph data by obtaining the right trade-off between providing minimal information (i.e., no neighbors) and exposing the model to an overly generalized graph (i.e., too many neighborhood hops).

Further technical benefits, including the improved accuracy of suggested links, are realized by aligning the multi-model data embeddings (e.g., the text embeddings and the graph embeddings). Overall, improved incident linking leads to improved phases of all of the entire incident management lifecycle. For example, the OCEs investigating the related incidents are able to better assist in identifying the right team for the newly reported incident. Similarly, identifying more accurate linked incidents accelerates root-cause analysis and subsequent steps of mitigation by avoiding siloed investigations by isolated individuals or teams.

### Example Computing Systems

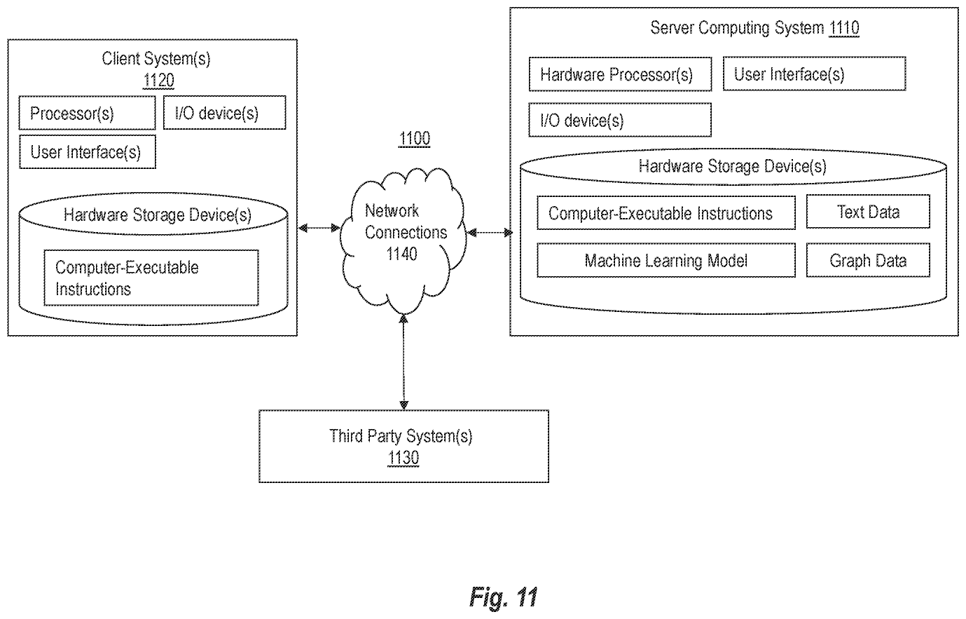

Attention will now be directed to FIG. 11, which illustrates the computing system 1110 as part of a computing environment 1100 that includes client system(s) 1120 and third-party system(s) 1130 in communication (via a network 1140) with the computing system 1110. As illustrated, computing system 1110 is a server computing system configured to compile, modify, and implement a machine learning model configured to generate and update dependency graphs, as well as generate, train, and use machine learning models to perform incident linking.

The computing system 1110, for example, includes one or more processor(s) (such as one or more hardware processor(s) and one or more hardware storage device(s) storing computer-readable instructions. One or more of the hardware storage device(s) is able to house any number of data types (e.g., graph data and/or text data) and any number of computer-executable instructions by which the computing system 1110 is configured to implement one or more aspects of the disclosed embodiments when the computer-executable instructions are executed by the one or more hardware processor(s). The computing system 1110 is also shown including user interface(s) and input/output (I/O) device(s).

As shown in FIG. 11, the hardware storage device(s) is shown as a single storage unit. However, it will be appreciated that the hardware storage device(s) is, a distributed storage that is distributed to several separate and sometimes remote systems and/or third-party system(s). The computing system 1110 can also comprise a distributed system with one or more of the components of computing system 1110 being maintained/run by different discrete systems that are remote from each other and that each performs different tasks. In some instances, a plurality of distributed systems performs similar and/or shared tasks for implementing the disclosed functionality, such as in a distributed cloud environment.

The computing system is in communication with client system(s) 1120 comprising one or more processor(s), one or more user interface(s), one or more I/O device(s), one or more sets of computer-executable instructions, and one or more hardware storage device(s). In some instances, users of a particular software application (e.g., Microsoft Teams) engage with the software at the client system which transmits the text or graph data to the server computing system to be processed, wherein the suggested links are displayed to the user on a user interface at the client system. Alternatively, the server computing system is able to transmit instructions to the client system for generating and/or downloading a machine learning model configured for incident linking.

The computing system is also in communication with third-party system(s). It is anticipated that, in some instances, the third-party system(s) 1130 further comprise databases housing data that could be used as training data, for example, text or graph data not included in local storage. Additionally, or alternatively, the third-party system(s) 1130 includes machine learning systems (e.g., AML endpoints) external to the computing system 1110.

Embodiments of the present invention may comprise or utilize a special-purpose or general-purpose computer (e.g., computing system 1110) including computer hardware, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media (e.g., hardware storage device(s) of FIG. 11) that store computer-executable/computer-readable instructions are physical hardware storage media/devices that exclude transmission media. Computer-readable media that carry computer-executable instructions or computer-readable instructions in one or more carrier waves or signals are transmission media. Thus, by way of example, and not limitation, embodiments of the invention can comprise at least two distinctly different kinds of computer-readable media: physical computer-readable storage media/devices and transmission computer-readable media.

Physical computer-readable storage media/devices are hardware and include RAM, ROM, EEPROM, CD-ROM or other optical disk storage (such as CDs, DVDs, etc.), magnetic disk storage or other magnetic storage devices, or any other hardware which can be used to store desired program code means in the form of computer-executable instructions or data structures and which can be accessed by a general purpose or special purpose computer.

A “network” (e.g., network 1240 of FIG. 11) is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry, or desired program code means in the form of computer-executable instructions or data structures, and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special-purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAS, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Various aspects of the present subject matter are set forth below, in review of, and/or in supplementation to, the embodiments described thus far, with the emphasis here being on the interrelation and interchangeability of the following embodiments. In other words, an emphasis is on the fact that each feature of the embodiments can be combined with each and every other feature unless explicitly stated otherwise or logically implausible.

In many example embodiments, a method for generating and updating a dependency graph for incident linking is provided, the method comprising: accessing domain data comprising a plurality of domains; generating a node for each domain of the plurality of domains in the dependency graph; accessing a first set of link data comprising a first set of correlating links between the plurality of domains; generating an edge between two or more nodes of the dependency graph for each correlating link included in the first set of correlating links; accessing a second set of link data comprising historical correlating links previously generated between two or more domains of the plurality of domains; dynamically updating the dependency graph by augmenting one or more edges of the dependency graph with the historical correlating links; and generating an updated dependency graph based on augmenting the one or more edges of the dependency graph with the historical correlating links.

In some instances, the first set of correlating links comprises self-reported correlating links between domains included in the plurality of domains.

In some instances, each domain of the plurality of domains represents a particular enterprise team.

Additionally, or alternatively, the second set of link data comprises historical correlating links from a predetermined timeframe.

In these example embodiments, the method can further comprise: prior to dynamically updating the dependency graph, updating the predetermined timeframe from which the historical correlating links are selected.

Additionally, or alternatively, the method can further comprise: prior to dynamically updating the dependency graph, weighting recent historical correlating links more heavily than older historical correlating links.

Example embodiments also include systems and methods for performing incident linking in large-cloud services. In such example embodiments, systems perform the following: identifying a new incident occurring in large-scale cloud services; accessing textual information about the new incident; accessing a dependency graph comprising a plurality of nodes representing a plurality of domains and a plurality of edges representing a plurality of correlating links between different domains of the plurality of domains; generating a set of text embeddings for the incident; generating a set of graph embeddings for the incident based on a sub-graph of the dependency graph associated with the new incident; aligning the set of text embeddings with the set of graph embeddings; generating a final set of joint embeddings for the incident based on aligning the set of text embeddings with the set of graph embeddings; and generating an output comprising predicting an incident correlating link between the new incident and a previously received incident based on calculating a similarity score between the final set of joint embeddings for the new incident and a final set of joint embeddings for the previously received incident.

In some aspects of the present embodiments, aligning the set of text embeddings with the set of graph embeddings further comprises projecting the set of text embeddings into a graph embedding space associated with the set of graph embeddings.

Additionally, in some aspects, prior to aligning the set of text embeddings with the set of graph embeddings, systems map the set of text embeddings into a high dimensional semantic embedding space and map the set of graph embeddings to a low dimensional embedding space.

In other aspects of example embodiments, aligning the set of text embeddings with the set of graph embeddings further comprises projecting the set of graph embeddings into a text embedding space associated with the set of text embeddings.

Additionally, or alternatively, aligning the set of text embeddings with the set of graph embeddings further comprises: projecting the set of graph embeddings to a shared representational space; and projecting the set of text embeddings to the shared representational space.

Some aspects of the example embodiments further comprise: prior to generating the set of graph embeddings, updating the dependency graph with a set of historical correlating links between the different domains of the plurality of domains.

In some example embodiments, systems are further configured to display the incident correlating link between the new incident and the previously received incident; and receive user input accepting or rejecting the incident correlating link.

In such example embodiments, systems can be further configured to: update the dependency graph based on the user input accepting or rejecting the incident correlating link.

Another aspect of the example embodiments herein can be configuring the categorical information to comprise one or more of a following: a monitoring identifier, a failure type, or an owning team identifier.

Additionally, or alternatively, the computing systems further access additional metadata corresponding to the new incident, including one or more of a following: a timestamp, component source, frequency, or severity level.

In some instances, prior to generating the final set of joint embeddings, the set of text embeddings that have been aligned with the set of graph embeddings are concatenated with the set of graph embeddings.

Some systems and methods are provided for training a machine learning model to predict correlation links between incidents in large-scale cloud services. These example embodiments include: accessing a set of graph embeddings based on a dependency graph comprising a plurality of nodes representing a plurality of domains and a plurality of edges representing a plurality of correlating links between different domains of the plurality of domains; accessing a set of textual embeddings corresponding to a plurality of incidents; aligning the set of textual embeddings with the set of graph embeddings to generate an aligned set of textual embeddings; generating a subgraph for each domain included in the plurality of domains; and training a machine learning model on a combination of each subgraph and a subset of the aligned set of textual embeddings corresponding to a subset of the set of graph embeddings associated with the subgraph.

Some additional aspects of these example embodiments include: generating a set of training data comprising triplet incidents including a positive related incident, a negative related incident, and an anchor incident corresponding to the positive related incident and the negative related incident; and then training the machine learning model on the set of training data

It should be noted that all features, elements, components, functions, and steps described with respect to any embodiment provided herein are intended to be freely combinable and substitutable with those from any other embodiment. If a certain feature, element, function, or step is described with respect to only one embodiment, it should be understood that each feature, element, function, or step can be used with any other embodiment described herein.

What is claimed is:

1. A computing system for performing incident linking in large-scale cloud services, the computing system comprising:
a processor; and
a hardware storage device storing computer-executable instructions that are executable by the processor to cause the computing system to at least:
identify a new incident occurring in large-scale cloud services;
access textual information about the new incident;
access a dependency graph comprising a plurality of nodes representing a plurality of domains and a plurality of edges representing a plurality of correlating links between different domains of the plurality of domains;
generate a set of text embeddings for the incident;
generate a set of graph embeddings for the incident based on a sub-graph of the dependency graph associated with the new incident;
align the set of text embeddings with the set of graph embeddings;
generate a final set of joint embeddings for the incident based on aligning the set of text embeddings with the set of graph embeddings; and
generate an output comprising an incident correlating link between the new incident and a previously received incident based on calculating a similarity score between the final set of joint embeddings for the new incident and a final set of joint embeddings for the previously received incident.

2. The computing system of claim 1, wherein the computer-executable instructions are further executable by the processor to cause the computing system to:
display the incident correlating link between the new incident and the previously received incident.

3. The computing system of claim 1, wherein the computer-executable instructions are further executable by the processor to cause the computing system to:
align the set of text embeddings with the set of graph embeddings by projecting the set of text embeddings into a graph embedding space associated with the set of graph embeddings.

4. The computing system of claim 3, wherein the computer-executable instructions are further executable by the processor to cause the computing system to:
prior to aligning the set of text embeddings with the set of graph embeddings, map the set of text embeddings into a high dimensional semantic embedding space and map the set of graph embeddings to a low dimensional embedding space.

5. The computing system of claim 1, wherein the computer-executable instructions are further executable by the processor to cause the computing system to:
align the set of text embeddings with the set of graph embeddings by projecting the set of graph embeddings into a text embedding space associated with the set of text embeddings.

6. The computing system of claim 1, wherein the computer-executable instructions are further executable by the processor to cause the computing system to:
align the set of text embeddings with the set of graph embeddings by:
projecting the set of graph embeddings to a shared representational space; and
projecting the set of text embeddings to the shared representational space.

7. A method implemented by a computing system for performing incident linking in large-scale cloud services, the method comprising:
identifying a new incident occurring in large-scale cloud services;
accessing textual information about the new incident;
accessing a dependency graph comprising a plurality of nodes representing a plurality of domains and a plurality of edges representing a plurality of correlating links between different domains of the plurality of domains;
generating a set of text embeddings for the incident;
generating a set of graph embeddings for the incident based on a sub-graph of the dependency graph associated with the new incident;
aligning the set of text embeddings with the set of graph embeddings;
generating a final set of joint embeddings for the incident based on aligning the set of text embeddings with the set of graph embeddings; and
generating an output comprising an incident correlating link between the new incident and a previously received incident based on calculating a similarity score between the final set of joint embeddings for the new incident and a final set of joint embeddings for the previously received incident.

8. The method of claim 7, wherein aligning the set of text embeddings with the set of graph embeddings further comprises projecting the set of text embeddings into a graph embedding space associated with the set of graph embeddings.

9. The method of claim 8, further comprising: prior to aligning the set of text embeddings with the set of graph embeddings, mapping the set of text embeddings into a high dimensional semantic embedding space and mapping the set of graph embeddings to a low dimensional embedding space.

11. The method of claim 7, wherein aligning the set of text embeddings with the set of graph embeddings further comprises projecting the set of graph embeddings into a text embedding space associated with the set of text embeddings.

12. The method of claim 7, wherein aligning the set of text embeddings with the set of graph embeddings further comprises:
projecting the set of graph embeddings to a shared representational space; and
projecting the set of text embeddings to the shared representational space.

13. The method of claim 7, further comprising:
prior to generating the set of graph embeddings, updating the dependency graph with a set of historical correlating links between the different domains of the plurality of domains.

14. The method of claim 7, further comprising:
displaying the incident correlating link between the new incident and the previously received incident; and
receiving user input accepting or rejecting the incident correlating link.

15. The method of claim 14, further comprising:
updating the dependency graph based on the user input accepting or rejecting the incident correlating link.

16. The method of claim 7, wherein the categorical information comprises one or more of a following: a monitoring identifier, a failure type, or an owning team identifier.

17. The method of claim 7, wherein the computing system further accesses additional metadata corresponding to the new incident, including one or more of a following: a timestamp, component source, frequency, or severity level.

18. The method of claim 7, further comprising:
prior to generating the final set of joint embeddings, concatenating (i) the set of text embeddings that have been aligned with the set of graph embeddings with (ii) the set of graph embeddings.

19. A method for training a machine learning model to predict correlation links between incidents in large-scale cloud services, the method comprising:
accessing a set of graph embeddings based on a dependency graph comprising a plurality of nodes representing a plurality of domains and a plurality of edges representing a plurality of correlating links between different domains of the plurality of domains;
accessing a set of textual embeddings corresponding to a plurality of incidents;
aligning the set of textual embeddings with the set of graph embeddings to generate an aligned set of textual embeddings;
generating a subgraph for each domain included in the plurality of domains; and
training a machine learning model on a combination of each subgraph and a subset of the aligned set of textual embeddings corresponding to a subset of the set of graph embeddings associated with the subgraph.

20. The method of claim 19, further comprising:
generating a set of training data comprising triplet incidents including a positive related incident, a negative related incident, and an anchor incident corresponding to the positive related incident and the negative related incident; and
training the machine learning model on the set of training data.
